(19) United States
(12) Patent Application Publication
(10) Pub. No.: US 2025/0249764 A1
(43) Pub. Date: Aug. 7, 2025

(54) SYSTEM FOR ESTABLISHING A CONDUCTIVE CONNECTION

(71) Applicant: Easelink GmbH, Graz (AT)

(72) Inventors: Friedrich LOBENSTOCK, Graz (AT); Martin ZAVERSKY, Graz (AT); Jernej GÜNTHER, Graz (AT)

(21) Appl. No.: 18/853,219

(22) PCT Filed: Apr. 3, 2023
(86) PCT No.: PCT/EP2023/058719

§ 371 Date: Oct. 1, 2024

(30) Foreign Application Priority Data
Apr. 4, 2022 (DE) 20 2022 103 788.4
Jul. 14, 2022 (DE) 10 2022 117 658.4

(51) Int. Cl. B60L 53/16; B60L 53/35; H01R 13/642; H01R 13/703

(52) U.S. Cl. CPC B60L 53/16; H01R 13/642; H01R 13/7039; B60L 53/35; H01R 2201/26

(57) ABSTRACT

A system for establishing a conductive connection with a plurality of contacts including at least one protective earth contact and power contacts. The at least one protective earth contact is hardwired. The power contacts are assigned to at least two different potentials which include a first potential and a second potential. A switching unit is provided, which is assigned at least to first power contacts of the power contacts. The switching unit is set up to connect at least the first power contacts selectively to the first potential or the second potential.

### FIELD OF THE INVENTION

The invention relates to a system for establishing a conductive connection, in particular between a vehicle contact unit and a ground contact unit.

### BACKGROUND

In the case of at least partially electrically driven vehicles, for example plug-in hybrid vehicles and purely electric vehicles, the batteries of the vehicles must be charged regularly, preferably after each journey. To this end, the vehicle is connected to a corresponding power source, usually using a plug, for example a so-called type 2 plug, which has to be manually inserted by a person into a corresponding socket on the vehicle. This ensures at the same time that the plug is guided so that the contact is made in a defined manner.

The prior art, for example WO 2019/052962 A1, furthermore discloses ground contact units for vehicle battery charging systems, which are provided on the ground. The ground contact units can automatically establish a conductive connection with a corresponding vehicle contact unit provided on the vehicle to be charged to charge the vehicle. The vehicle contact unit can be provided on the underbody of the vehicle, wherein it moves downwards to establish the electrical contacting with the ground contact unit.

For example, the ground contact unit is designed as a so-called matrix charging pad, as shown in WO 2019/052962 A1. For this purpose, the ground contact unit comprises a multitude of contacts arranged in a matrix-like manner, the contacts being adapted to be contacted by means of the vehicle contact unit to establish an electrical connection between the ground contact unit and the vehicle contact unit.

It may be provided that the vehicle contact unit is precisely aligned with respect to the ground contact unit before a connector of the vehicle contact unit contacts the ground contact unit at a defined point. Alternatively, it may be provided that no guide is provided for the vehicle contact unit and/or no precise contacting, a touchdown point of the connector of the vehicle contact unit then having to be detected on the ground contact unit. Depending on the touchdown point, the correspondingly occupied contacts of the ground contact unit are activated to establish the electrical connection via these contacts.

Typically, the occupied contacts are connected by means of separate relays which are assigned to each contact of the ground contact unit. This results in a so-called matrix relay, which, among other things, ensures the safety-relevant requirements with regard to the insulation distance. However, this is associated with high costs as each contact has its own relay.

In this respect, the systems known from the prior art for establishing a conductive connection are complex and associated with high costs.

### SUMMARY

The object is to provide a system for establishing a conductive connection by means of which the conductive connection can be established in a simple and cost-effective manner.

According to the invention, the object is achieved by a system for establishing a conductive connection, in particular between a vehicle contact unit and a ground contact unit. The system has a plurality of contacts comprising at least one protective earth contact and power contacts, wherein the at least one protective earth contact is hardwired. The power contacts are assigned to at least two different potentials which comprise a first potential and a second potential. A switching unit is furthermore provided which is assigned to at least first power contacts of the power contacts, wherein the switching unit is set up to connect at least the first power contacts selectively to the first potential or the second potential.

The basic idea of the invention is to assign a plurality of power contacts, namely the first power contacts, jointly to a specific potential by the switching unit connecting the corresponding power contacts, i.e. the first power contacts, either to the first potential or to the second potential. In other words, depending on its switching position, the switching unit ensures that the first power contacts are connected either to the first potential or to the second potential. Depending on the switching position of the switching unit, all first power contacts are therefore connected either to the first potential or to the second potential. All first power contacts are assigned to a first power contact plane.

Basically, the power contacts are the contacts through which a charging current is routed when a motor vehicle, in particular the battery bank thereof, is charged.

In addition, the contacts comprise at least one protective earth contact, which, in contrast to the first power contacts, is hardwired. In other words, the at least one protective earth contact has a fixed wiring so that it is not connected to the switching unit or assigned thereto. In this respect, it is not possible, either, for the protective earth contact to be connected to a potential, for example, as is the case in the prior art, for example, when all contacts are connected to the switching unit.

The position of the at least one protective earth contact is therefore fixed, thus unchangeable. In contrast thereto, the positions of the contacts assigned to the first or second potential can be changed, as at least the first power contacts can selectively be connected to the first potential or to the second potential.

In particular, the contacts also have second power contacts, which can also be selectively connected to the first potential or the second potential via the switching unit. All second power contacts are assigned to a second power contact plane.

In particular, the switching unit is therefore also assigned at least to the second power contacts, the switching unit being set up to connect the second power contacts selectively to the first potential or to the second potential.

In principle, it may then be provided that the switching unit has a first switching position in which the first power contacts are connected to the first potential and the second power contacts are connected to the second potential. In addition, the switching unit has a second switching position in which the first power contacts are connected to the second potential and the second power contacts are connected to the first potential. In this respect, the first power contacts and the second power contacts can selectively be connected to the two potentials, i.e. the first potential and the second potential. This ensures that the first power contacts and the second power contacts are never connected to the same potential.

The two potentials may be two potentials of a DC or an AC application, for example a positive pole and a negative pole in the case of a DC application or a neutral (N) and a phase (L1, L2 or L3) or two phases in the case of an AC application. For example, the first potential is the neutral (N).

Due to the hardwired protective earth contact and the first power contacts, which are selectively connected to the first or second potential, the number of relays used can be reduced.

Furthermore, the at least one protective earth contact may be designed to provide a magnetic contact via which the connection between the vehicle contact unit and the ground contact unit can be maintained. In other words, the at least one protective earth contact can be magnetized.

The switching unit may comprise a plurality of switches, for example two switches which ensure that the first power contacts are connected to the first potential or the second potential.

The system may have a control unit which is set up to drive the switching unit, in particular the respective switching position of the switching unit. In particular, the control unit drives the plurality of switches, for example jointly and/or simultaneously.

One aspect provides that a plurality of power contacts is respectively assigned to one power contact plane. The switching unit is set up to connect all power contacts of the assigned power contact plane selectively to the first potential or to the second potential. In this respect, the power contacts are switched in groups via the switching unit, as all power contacts of a corresponding power contact plane are jointly connected to the first potential or the second potential or activated.

In particular, all power contacts are assigned to four power contact planes, which are adapted to be connected to a neutral and to three phases. In this respect, this may involve a three-phase connection having a neutral N and three phases L1, L2, L3. If only two power contact planes are provided, however, it may be a DC application.

For example, the power contacts are each connected to the assigned power contact plane via a contact switch. It can thus be ensured that only those power contacts of the corresponding potential which are used for the charging process are activated. In other words, it is possible to switch the individual power contacts potential-free via the corresponding contact switches if, in the event of a conductive connection, they are for example not in contact with other power contacts, i.e. power contacts of the other contact unit.

In particular, the contact switches are each designed as a mirror contact, the contact switches having a main contact and a monitoring contact which are mechanically coupled but galvanically isolated from each other. The main contact and/or the monitoring contact of the contact switch may be a switch having an open position and a closed position. In this respect, the main contact or the monitoring contact is designed as an on/off switch. This means that the main contact or the monitoring contact can be shifted between an open position and a closed position. Since the main contact is designed as a switch having an open position and a closed position, the main contact cannot weld when opening if it moves from its closed position, in which the charging current flows through the main contact, to a second position which does not correspond to an open position, but to a closed position with another counterpart, for example, ground.

When opening, an arc can be generated which would then cause the main contact to weld in the second (closed) position, so that the main contact and thus the entire contact switch could no longer be shifted. This is effectively prevented if at least the main contact is designed as a switch having an open position and a closed position.

However, it may also be provided that the main contact and/or the monitoring contact can be switched between two or more different closed positions.

However, the main contact and the monitoring contact are in any case galvanically isolated from each other, so that a common (closed) circuit is not formed via the two contacts, i.e. the main contact and the monitoring contact. The two contacts are therefore not used to provide a charging function in one switching position of the contact switch and a sensor function or similar in the other switching position of the contact switch. Rather, the main contact and the monitoring contact are assigned to two independent circuits which are galvanically isolated from each other.

Monitoring can take place during the charging process, but also before and/or after a charging process, in particular in connection with a self-test. Furthermore, monitoring can take place at cyclic intervals.

If a faulty or incorrect switching position is detected, a warning can be issued, for example a visual warning, an acoustic warning and/or a warning by means of a remote signaling contact. Likewise, it may be provided that charging is not possible, i.e. no charging process can be started, if a faulty or incorrect switching position has been detected during the check.

A further aspect provides that the power contacts also include second power contacts, third power contacts and fourth power contacts in addition to the first power contacts. The four types of power contacts are assigned to a neutral and to three phases. In particular, each of the four types of power contacts is assigned to a corresponding power contact plane of the four power contact planes. In the case of four different power contact planes, the power contacts therefore comprise first power contacts, second power contacts, third power contacts and fourth power contacts, which are each assigned to a corresponding power contact plane, so that the different power contacts may be adapted to be selectively connected to the neutral or to one of the three phases. The corresponding system is therefore designed to be used with a three-phase connection, so that the conductive connection for charging the motor vehicle, in particular the battery bank thereof, can be established via a three-phase current.

The four different power contact planes each have a plurality of power contacts, which can respectively be activated collectively, i.e. all power contacts of an assigned power contact plane, to a different potential via the assigned switching unit. This means, for example, that the first power contact plane, i.e. the first power contacts, can selectively be connected to the first potential or to the second potential. This results, for example, in that at least the second power contacts, i.e. all power contacts of the second power contact plane, can be connected to the respectively other potential, so that the four power contact planes, i.e. the respective power contacts of these power contact planes, are respectively connected to different potentials.

It may basically be provided that all power contact planes can be connected to all available potential via the switching unit, thus ensuring maximum flexibility.

In a simple configuration of the system, it may be provided that the switching unit is respectively assigned only to two power contact planes, i.e. two types of power contacts, to be able to selectively switch the first power contacts and the second power contacts between the first potential and the second potential. This means that the switching unit is set up to connect the first power contacts either to the first potential or to the second potential, the second power contacts being simultaneously connected to the corresponding other potential. This ensures that the first power contacts and the second power contacts are always connected to different potentials.

The third and fourth power contacts can be hardwired. Alternatively, it may be provided that the switching unit is also assigned to the third and fourth power contacts. In the simple embodiment, as already explained, only the first and second power contacts can be switched between different potentials via the switching unit. In contrast thereto, the third and fourth power contacts, i.e. all power contacts of the third and fourth power contact planes, are hardwired, as is also the case for the at least one protective earth contact.

However, in a more flexible configuration of the system, it is possible that the third power contacts and the fourth power contacts can also each be connected to different potentials, which basically makes it possible for all types of power contacts to be connected to different potentials.

It may be provided that one power contact of each of the four types of power contacts is arranged in a rectangle. This means that the four types of power contacts together form a rectangle in a plane, the respective corners of the rectangle being occupied by the different types of power contacts. For example, a first power contact is provided in an upper right corner of the rectangle, whereas the second power contact is provided in a lower right corner of the rectangle. The third power contact can be provided in a lower left corner of the rectangle, whereas the fourth power contact is provided in an upper left corner of the rectangle. In this respect, the four types of power contacts together form a rectangle in the corresponding plane, which may also be referred to as a charging plane or charging surface.

In particular, the at least one protective earth contact is arranged in the center of the rectangle. Accordingly, the protective earth contact is at an equal distance from the respective different types of power contacts arranged around it.

The rectangle formed by the four types of power contacts may be a square.

In principle, a plurality of protective earth contacts may be provided. In particular, the protective earth contacts are each arranged in the center of a rectangle the respective corners of which are formed by the four types of power contacts.

The contacts may be arranged such that a plurality of rectangles is formed the respective corners of which are formed by the four types of power contacts.

It may also be provided that the at least one protective earth contact is formed by a continuous surface which provides a protective earth plane which is interrupted by the power contacts. The corresponding protective earth plane is also referred to as PE plane. In other words, a connection surface, for example a charging surface of the ground contact unit, can be formed for the most part by the protective earth contact, the corresponding power contacts being arranged in the plane formed by the protective earth contact, in particular with an annular insulating region, to electrically insulate the power contacts from the protective earth contact, i.e. from the corresponding protective earth plane.

According to one embodiment, it is provided that the switching unit is composed of four switches, ten switches or sixteen switches. The number of the respective switches depends on how flexibly the corresponding system is designed and how many power contact planes can be flexibly connected to different potentials. In a simple configuration, in which only the first power contacts and the second power contacts can be flexibly connected to different potentials, it is sufficient to provide four switches, as one switch is respectively provided between a power contact plane and two potentials, so that two power contact planes are each connected to two potentials via two switches. In other words, the first power contact plane is connected to the first potential and the second potential via two switches, and the second power contact plane is connected to the first potential and the second potential via two switches.

With four switches, it is for example possible to switch the neutral with a phase or to switch two phases with each other or to switch the positive pole with the negative pole.

With ten switches, it is for example possible to switch the neutral to any phase. The direction of rotation would not be maintained.

With twelve switches, it is in addition possible to maintain the right-hand rotating field.

With 16 switches, it is additionally possible to freely select the utilized phase for a single-phase transmission, and to selectively realize a parallel transmission from one phase to two power contacts.

In particular, the switches are each designed as mirror contacts and have a main contact and a monitoring contact which are mechanically coupled but galvanically isolated from each other. The main contact and/or the monitoring contact may (respectively) be a switch having an open position and a closed position. In this respect, the main contact and/or the monitoring contact is designed as an on/off switch. This means that the main contact and/or the monitoring contact can be shifted between an open position and a closed position. As the main contact is designed as a switch having an open position and a closed position, the main contact cannot weld when opening if it moves from its closed position, in which the charging current flows through the main contact, to a second position which does not correspond to an open position, but to a closed position with another counterpart, for example ground. However, it may also be provided that the main contact and/or the monitoring contact can be switched between two or more different closed positions.

In any case, the main contact and the monitoring contact are galvanically isolated from each other, so that a common (closed) circuit is not formed via the two contacts, i.e. the main contact and the monitoring contact. The two contacts are therefore not used to provide a charging function in one switching position and a sensor function or similar in the other switching position. Rather, the main contact and the monitoring contact are assigned to two independent circuits that are galvanically isolated from each other.

Monitoring can generally take place during the charging process, but also before a charging process and/or after a charging process, in particular in connection with a self-test. Furthermore, the monitoring can be carried out at cyclic intervals.

If a faulty or incorrect switching position is detected, a warning can be issued, for example a visual warning, an acoustic warning and/or a warning by means of a remote signaling contact. It may also be provided that charging is not possible, i.e. that no charging process can be started, if a faulty or incorrect switching position has been detected during the check.

A further aspect provides that the system has an input interface which is connected at least to the first and to the second potential, in particular to all potentials, the system having an output interface connected to the power contacts. The switching unit is arranged between the input interface and the output interface. In this respect, the available potentials are connected to the input interface of the system via the switching unit. Depending on the switching position, the switching unit connects the corresponding power contacts to the corresponding potentials, thus ensuring that all power contacts of a corresponding power contact plane, i.e. all power contacts of the same type, are connected to a defined potential.

Furthermore, the contacts may also comprise at least one control contact for detecting a contacting. The at least one control contact is formed separately from the power contacts and separately from the at least one protective earth contact. The control contact can be used to determine whether a contacting is present. It is in particular also possible to determine, via the control contact, in particular via two control contacts, the orientation with which the vehicle contact unit and the ground contact unit have formed the conductive connection, as a result of which the corresponding power contacts are connected to potentials via the switching unit.

Furthermore, the at least one control contact may also be designed to provide a magnetic contact via which the connection between the vehicle contact unit and the ground contact unit can be maintained. In other words, the at least one control contact can be magnetized.

In principle, the magnetic contact, for example the magnetizable control contact, can be used to ensure that the vehicle contact unit and the ground contact unit form the conductive connection in a defined manner, in particular via at least two magnetic contacts which are provided on both the vehicle contact unit and the ground contact unit and interact. The at least two magnetic contacts may be provided via two protective earth contacts, two control contacts or via one protective earth contact and one control contact.

The at least one control contact can be hardwired.

According to a further aspect, the system comprises a vehicle contact unit, which comprises the plurality of contacts, and/or a charging infrastructure which comprises a ground contact unit, which has a plate-shaped base body having a charging surface on which the plurality of contacts is arranged and against which the vehicle contact unit can come to rest. In this respect, the system can be provided both on the vehicle side and on the charging infrastructure side. In other words, the power contacts can be connected to the respective potential both on the vehicle side and on the charging infrastructure side.

In principle, it may also be provided that one power contact of each of the four types of power contacts is arranged in the corners of a common rectangle, in particular on the charging surface of the base body. In other words, a different type of power contact is provided in each corner of the rectangle. The rectangle may be a square.

The at least one control contact may be arranged in the center of the rectangle. Accordingly, it may be provided that instead of the at least one protective earth contact, the at least one control contact is arranged in the center of the rectangle. This may in particular be the case if the protective earth contact is designed as a protective earth plane which is interrupted both by the power contacts and by the at least one control contact.

In any case, a magnetic contact may be provided in the center of the respective rectangle. This ensures that defined contacting points are provided for establishing the conductive connection.

Thus, a centered-square pattern may be provided with regard to the power contacts. This is more advantageous than a hexagonal pattern, since the number of relays can be reduced, which are necessary to ensure transmission on each touchdown position of the vehicle contact unit on the ground contact unit.

To enable the connection between the vehicle contact unit and the ground contact unit (“snapping”) at two adjacent protective earth contacts in the centered-square pattern, it may be provided to design the power contacts assigned to the neutral, for example the first power contacts, so that they can be exchanged with at least one phase. This ensures that the position of the power contacts assigned to the neutral position matches both connection positions (“snapping positions”).

As a result, a maximum necessary relative rotation of the vehicle contact unit can be limited to 180°, as a result of which the vehicle contact unit can be designed to be accordingly less complex compared to a vehicle contact unit where a 360° relative rotation is necessary.

### BRIEF DESCRIPTION OF THE DRAWINGS

Further advantages and features of the invention will become apparent from the descriptions and the drawings below, to which reference is made and in which:

FIG. 1 shows a schematic overview of a vehicle battery charging system with a system according to the invention,

FIG. 2 shows a schematic top view of a ground contact unit of an electric charging infrastructure of a system according to the invention in accordance with one embodiment,

FIG. 3 shows a schematic top view of a ground contact unit of an electric charging infrastructure of a system according to the invention in accordance with a further embodiment,

FIG. 4 shows a schematic representation of the electrical connection of the power contacts of the system according to a first variant embodiment of the system according to the invention,

FIG. 5 shows a schematic representation of the electrical connection of the power contacts of the system according to the invention in accordance with a second variant embodiment of the system according to the invention, and

FIG. 6 shows a schematic representation of the electrical connection of the power contacts of the system according to the invention in accordance with a third variant embodiment of the system according to the invention.

### DETAILED DESCRIPTION

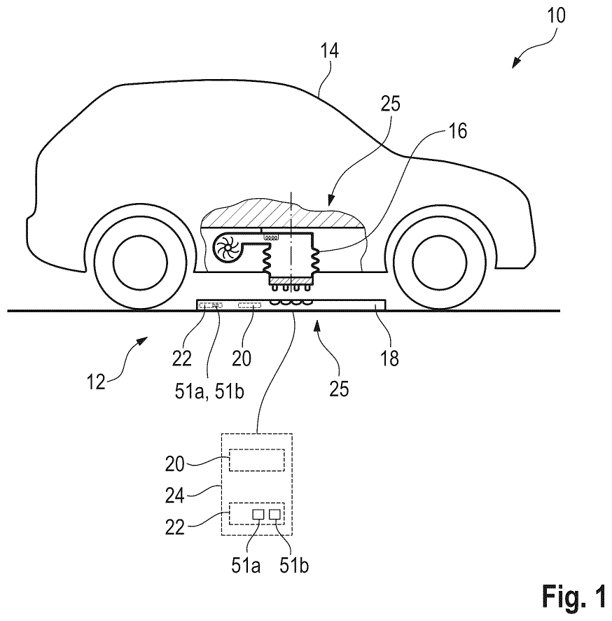

FIG. 1 shows a vehicle battery charging system 10, which shows an electric charging infrastructure 12 and an at least partially electrically driven vehicle 14.

The vehicle 14 has a vehicle contact unit 16 which can establish a conductive connection with a ground contact unit 18 of the electric charging infrastructure 12 to charge a battery of the vehicle 14 not shown in more detail here.

The electric charging infrastructure 12 has a monitoring circuit 20 and a switch-off device 22, which can be fully integrated into the ground contact unit 18. Alternatively, the monitoring circuit 20 can be arranged partly in the ground contact unit 18 and partly in a monitoring unit 24 formed separately from the ground contact unit 18. Furthermore, it can be provided that the monitoring circuit 20 and the switch-off device 22 are both completely arranged in the separately formed monitoring unit 24.

The separately formed monitoring unit 24 is therefore optional, which is why it is shown in dashed lines in FIG. 1. Similarly, the monitoring circuit 20 and the switch-off device 22 are shown in dashed lines, as their respective positions may vary depending on the design.

In any case, the separately formed monitoring unit 24 would be electrically connected to the ground contact unit 18, as indicated in FIG. 1.

Alternatively, it may however also be provided that the monitoring circuit 20 and/or the switch-off device 22 are provided on the vehicle side, as will be explained below.

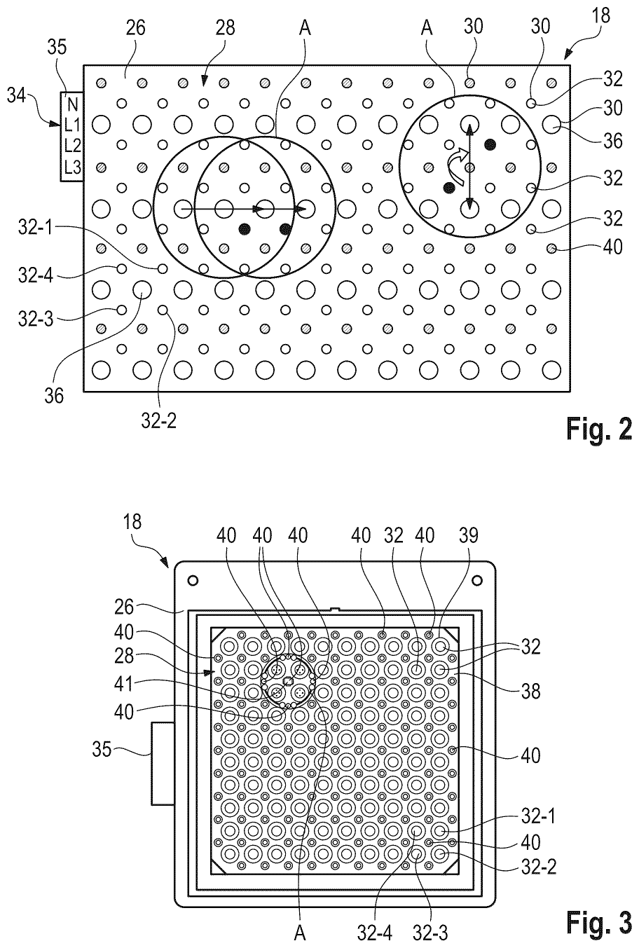

In principle, both the charging infrastructure 12 and the vehicle contact unit 16 can have a system 25 for establishing a conductive connection, as will be explained below with reference to FIGS. 2 to 6. In particular, the corresponding system 25 is provided to form a conductive connection between the vehicle contact unit 16 and the ground contact unit 18.

The monitoring circuit 20 and the switch-off device 22, in particular also the separately formed monitoring unit 24, can thus be part of the corresponding system 25.

FIG. 2 shows a top view of the ground contact unit 18 according to one variant embodiment.

The ground contact unit has a plate-shaped base body 26, which includes a charging surface 28 which is exposed before the conductive connection is established. The charging surface 28 is an exposed charging surface when the contacting is established between the ground contact unit 18 and the vehicle contact unit.

However, the charging surface can basically be covered by a cover (not shown here) when not in use, so that the charging surface 28 is protected from environmental influences, among other things. The corresponding cover can be removed manually or automatically, making the charging surface 28 freely accessible.

A plurality of contacts 30 of different contact forms or contact types is provided on the charging surface 28.

In any case, the contacts 30 comprise, among other things, a plurality of power contacts 32 used for the charging process of the battery of the vehicle 14. When the vehicle 14 is charging, in particular when the battery of the vehicle 14 is charging, a charging current flows across at least a part of the power contacts 32. For this purpose, the corresponding power contacts 32 are basically assigned to at least one potential 34, as will be explained in more detail below.

In the embodiment shown, the ground contact unit 18 is configured as a three-phase ground contact unit 18, which means that the individual power contacts 32 can be assigned to four different potentials 34, namely to neutral N and the phases L1, L2 and L3. The neutral N is also referred to as neutral conductor. Accordingly, this involves the corresponding potentials N, P1, P2 and P3.

As can be seen from FIG. 2, a corresponding three-phase connection 35 is therefore provided.

The power contacts 32 are therefore subdivided into power contact planes P1, P2, P3, P4 or assigned to the power contact planes, which are also referred to as “pin layers”.

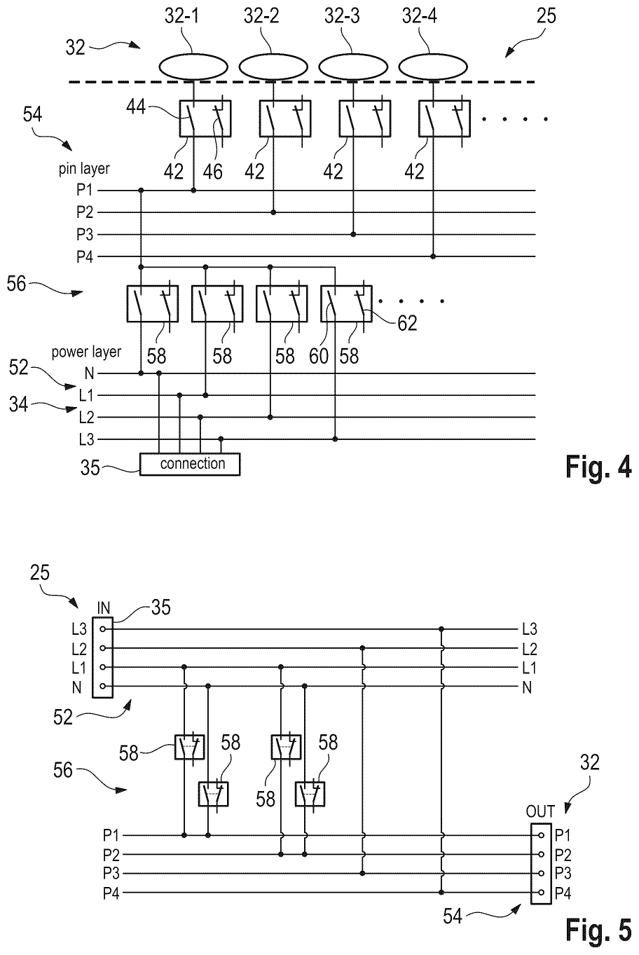

In this respect, there are four types of power contacts 32, namely first power contacts 32-1, which are assigned to the first power contact plane P1, second power contacts 32-2, which are assigned to the second power contact plane P2, third power contacts 32-3, which are assigned to the third power contact plane P3, and fourth power contacts 32-4, which are assigned to the fourth power contact plane P4. This can be clearly seen in FIGS. 4 to 6, to which reference will be made below when describing the connection of the power contacts 32.

FIG. 2 already shows that the four types of power contacts 32 are arranged in a rectangle, in particular in a rectangle on the charging surface 28.

In the illustrated example embodiment, the first power contact 32-1 is provided in an upper right corner of the rectangle, whereas the second power contact 32-2 is provided in the lower right corner of the rectangle. The third power contact 32-3 is provided in a lower left corner of the rectangle, whereas the fourth power contact 32-4 is provided in an upper left corner of the rectangle. In this respect, the four types of power contacts 32 together form the rectangle in the corresponding plane.

In addition to the power contacts 32, the contacts 30 also include at least one protective earth contact 36, i.e. a PE contact. In the embodiment shown in FIG. 2, a plurality of protective earth contacts 36 arranged separately and insulated from the power contacts 32 on the charging surface 28 is provided.

Furthermore, the embodiment shown in FIG. 2 shows that the protective earth contacts 36 are each arranged in the center of the rectangles.

The rectangles are in particular designed as squares so that the protective earth contact 36 arranged in the center is at the same distance from each of the power contacts 32. In this respect, FIG. 2 provides for a centered-square pattern with regard to the power contacts 32 and the protective earth contacts 36.

Alternatively to the embodiment shown in FIG. 2, the ground contact unit 18 can have a continuous protective earth plane 38, which therefore substantially corresponds to the surface of the base body 26 or the base surface of the charging surface 28, as shown in FIG. 3.

The individual power contacts 32 then break through the corresponding protective earth plane 38, the power contacts 32 being respectively arranged in an insulated manner with respect to the protective earth plane 38, for example by means of annular insulating sections 39 which insulate the power contacts 32 from the protective earth plane 38.

In addition, the contacts 30 can basically comprise at least one control contact 40, which is used to carry out a contacting check, that is to determine whether the vehicle contact unit 16 contacts the ground contact unit 18.

In the embodiment shown in FIGS. 2 and 3, a plurality of control contacts 40 is provided.

The control contacts 40 and/or the protective earth contacts 36 can in principle be designed as magnetic contacts 41, i.e. they can be magnetized. This makes it possible for the conductive connection to be established only in a defined manner, namely such that at least one magnetic contact 41 of the vehicle contact unit 16 couples with a magnetic contact 41 of the ground contact unit 18.

The defined connection is ensured because the magnetic contacts 41 are each arranged in the center of an assigned rectangle, in particular a square, in each corners of which one type of power contacts 32 is provided, i.e. a first power contact 32-1, a second power contact 32-2, a third power contact 32-3 and a fourth power contact 32-4. Consequently, either a protective earth contact 36 or a control contact 40 can be provided in the center of the respective rectangle.

In particular, the contacts 30 are distributed on the charging surface 28 and arranged in relation to each other such that at least two control contacts 40 are located in a contacting area A of the charging surface 28 which is covered by the vehicle contact unit 16 when the conductive connection is established. The two control contacts 40 in the contact area A can then be used to determine the orientation in which the ground contact unit 18 has been contacted.

Furthermore, by knowing the geometry of the vehicle contact unit 16, it can be determined which contacts 30 have been contacted, that is, which of the contacts 30 belong to the subset of the contacted contacts 30 located in the contacting area A of the charging surface 28.

Based on this information, the corresponding power contacts 32 can then be switched to assign a specific potential 34 to the different power contact planes P1 to P4.

FIG. 4 shows how the power contacts 32 are connected, using an example of a variant embodiment. This basically applies to the connection of the power contacts 32 of the vehicle contact unit 16 and to the connection of the power contacts 32 of the ground contact unit 18.

The individual power contacts 32 can each be connected to a corresponding power contact plane P1 to P4 via contact switches 42, so that the individual power contacts 32 can be activated or deactivated via the contact switches 42.

This makes it possible to connect only those power contacts 32 of a corresponding potential 34 that are located in the contacting area A, so that exposed power contacts 32 are potential-free.

FIG. 4 also shows that the respective contact switches 42 are designed as mirror contacts, so that the contact switches 42 have a main contact 44 and a monitoring contact 46. The design as a mirror contact ensures that the main contact 44, which acts as a relay, is mechanically coupled to the monitoring contact 46, so that the respective switching positions of the main contact 44 and the monitoring contact 46 are conditioned or dependent on each other. However, the main contact 44 and the monitoring contact 46 are galvanically isolated from each other, so that the two contacts 44, 46 are not assigned to a common circuit. Rather, the two contacts 44, 46 are assigned to different circuits which are independent of each other and also galvanically isolated from each other.

In this respect, there is no switching position of the contact switch 42 in which a closed circuit is formed in which both the main contact 44 and the monitoring contact 46 are integrated, so that a current could flow across both contacts 44, 46 of the contact switch 42. As shown in FIG. 4, the main contact 44 is designed as a normally open contact, i.e. an NO contact, whereas the monitoring contact 46 is designed as a normally closed contact, i.e. an NC contact.

FIG. 4 thus shows the initial position of the contact switches 42, since the contact switches 42 are each in a corresponding switching position in which the main contacts 44 are open, so that no current flow to the power contacts 32 is possible. In other words, the power contacts 32 are not connected to any potential 34, thus ensuring protection against accidental contact.

The corresponding protection against accidental contact can be monitored in that the monitoring circuit 20 monitors, among other things, the respective switching position of the monitoring contacts 46 of the corresponding contact switches 42.

The monitoring takes place at least at the contact switches 42 which are assigned to power contacts 32 which are not contacted when the conductive connection is present between the ground contact unit 18 and the vehicle contact unit 16, that is, for power contacts 32 which do not belong to the subset of the plurality of contacts 30 of the ground contact unit 18 which is contacted.

The monitoring circuit 20 drives the switch-off device 22 if the monitoring circuit 20 determines that one of the monitoring contacts 46 has an incorrect switching position, which results in one of the main contacts 44 also having an incorrect switching position, since the monitoring contacts 46 and the main contacts 44 are mechanically coupled to each other.

The incorrect switching position corresponds to an open switching position of the monitoring contact 46, which is accompanied by a closed switching position of the associated main contact 44, which would mean that a freely accessible power contact 32 would be assigned to a potential 34, although this is not desired because the corresponding power contact 32 is exposed.

The switch-off device 22 changes its state due to the driving by the monitoring circuit 20, which may be accompanied by a complete switching-off or a complete disconnection. In other words, the switch-off device 22 can be configured such that a galvanic isolation of all power contacts 32 is performed, as a result of which all power contacts 32 would be switched potential-free.

In this respect, the switch-off device 22 can comprise a main switch 51a or a contactor which performs the corresponding galvanic isolation.

Alternatively, the switch-off device 22 can comprise an electronic power control 51b which is designed to reduce the voltage assigned to the potential 34 accordingly, so that the applied voltage is limited to an non-critical value, thus ensuring protection against accidental contact. In other words, the voltage applied to the respective power contact 32, which is coupled to the erroneously closed main contact 44 of the contact switch 42, is so low that there is no danger.

Furthermore, the system 25 comprises an input interface 52 which is assigned to the connection 35 and the potentials 34.

Furthermore, the system 25 comprises an output interface 54, which is connected to the power contacts 32, in particular to the power contact planes P1 to P4.

The system 25 also comprises a switching unit 56, which is provided between the input interface 52 and the output interface 54.

The switching unit 56 has a plurality of switches 58 basically set up to switch the power contacts 32 respectively assigned to a power contact plane P1 to P4 jointly selectively between a first potential 34 and a second potential 34, for example between neutral N and the first phase L1.

The switching unit 56 ensures, for example, that at least the first power contacts 32-1, i.e. the power contacts 32 which are assigned to the first power contact plane P1, can selectively be connected to the first potential 34 (neutral N) or to the second potential 34 (first phase L1).

In the embodiment shown in FIG. 4, the system 25 is configured such that all power contact planes P1 to P4, that is, the respective power contacts 32 in groups, can selectively be connected to any of the potential 34 present, so that maximum flexibility is ensured.

The section shown in FIG. 4 shows the four different types of power contacts 32, i.e. a first power contact 32-1, a second power contact 32-2, a third power contact 32-3 and a fourth power contact 32-4. In other words, power contacts 32 are shown which are assigned to the first power contact plane P1, the second power contact plane P2, the third power contact plane P3 and the fourth power contact plane P4, or are connected thereto via the corresponding contact switches 42.

Basically, the switches 58 can also be designed as mirror contacts, like the contact switches 42, so that the switches 58 have a main contact 60 and a monitoring contact 62.

In contrast to the power contacts 32, the at least one protective earth contact 36 is hardwired, which means that the at least one protective earth contact 36 or the protective earth plane 38 is fixed and cannot be connected to one of the potentials 34.

This applies equally to the control contacts 40, which are also hardwired.

In contrast thereto, FIG. 5 shows a simplified variant embodiment of the system 25 with regard to the connection of the power contacts 32.

The power contacts 32 of the third power contact plane P3 and those of the fourth power contact plane P4, i.e. the third power contacts 32-3 and the fourth power contacts 32-4, are hardwired. Only the power contacts 32 of the first power contact plane P1 and those of the second power contact plane P2, i.e. the first power contacts 32-1 and the second power contacts 32-2, can selectively be switched between two potentials 34 via the switching unit 56. In the present case, this involves the neutral N and the first phase L1.

According to the variant embodiment shown, the switching unit 56 comprises four switches 58, two switches 58 being respectively assigned to the first power contact plane P1 and two further switches 58 being assigned to the second power contact plane P2. The first power contact plane P1 and the second power contact plane P2 are each assigned, via a switch 58, to the first potential 34, which in the present case is formed by the neutral N, and, via a switch 58, to the second potential 34, which in the present case is formed by the first phase L1.

In this respect, it is possible to selectively switch the first power contacts 32-1 between neutral N and the first phase position L1, the second power contacts 32-2 being at the same time selectively connected to neutral N or the first phase L1.

The switching unit 56 is designed such that the individual switches 58 are driven such that each of the power contact planes P1 to P4 is assigned to exactly one potential 34. This prevents, among other things, the first power contact plane P1 and the second power contact plane P2 from being both connected to a common potential 34.

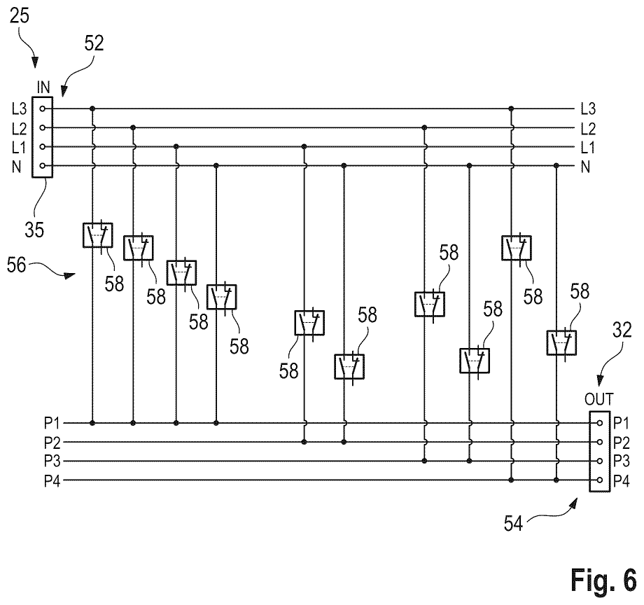

FIG. 6 shows a further variant embodiment in which the switching unit 56 comprises a total of ten switches 58.

The first power contacts 32-1, that is, the power contacts 32 of the first power contact plane P1, can be connected to any of the four potentials 34 via the switching unit 56, since four switches 58 are assigned to the first power contact plane P1, each of which is assigned to one of the four potentials 34, i.e. the neutral N and the three phases L1, L2 and L3.

In contrast thereto, only two switches 58 are provided for each of the three further power contact planes P2 to P4, so that the corresponding power contacts 32 of the second power contact plane P2 to the fourth power contact plane P4 can only be switched between two different potentials 34, one of which is always the neutral N. In the variant embodiment shown in FIG. 6, it is therefore possible that the neutral N can be switched at each of the corners of the corresponding rectangle in the contacting area A.

It is thus basically provided, by means of the switching unit 56, that the different power contacts 32, i.e. the respective types of power contacts 32, are switched in groups. In this respect, all power contacts 32 belonging to a power contact plane P1-P4 are jointly connected to a specific potential 34 via the switching unit 56, so that the corresponding power contacts 32 are connected to the selected potential 34, for example all first power contacts 32-1, all second power contacts 32-2, all third power contacts 32-3 or all fourth power contacts 32-4.

1. A system for establishing a conductive connection, the system having a plurality of contacts comprising at least one protective earth contact and power contacts, wherein the at least one protective earth contact is hardwired, wherein the power contacts are assigned to at least two different potentials which comprise a first potential and a second potential, and wherein a switching unit is provided which is assigned to at least first power contacts of the power contacts, wherein the switching unit is set up to connect at least the first power contacts selectively to the first potential or the second potential.

2. The system (25) according to claim 1, wherein a plurality of the power contacts 2) is respectively assigned to one power contact plane, wherein the switching unit is set up to connect all power contacts of the assigned power contact plane selectively to the first potential or the second potential.

3. The system according to claim 2, wherein the power contacts are each connected to the assigned power contact plane via a contact switch.

4. The system according to claim 1, wherein the power contacts also comprise second power contacts, third power contacts, and fourth power contacts in addition to the first power contacts, wherein the four types of power contacts are assigned to a neutral and to three phases.

5. The system according to claim 4, wherein the third power contacts and the fourth power contacts are hardwired or the switching unit is also assigned to the third power contacts and the fourth power contacts.

6. The system according to claim 4, wherein one power contact of the four types of power contacts is respectively arranged in a rectangle.

7. The system according to claim 1, wherein the switching unit is composed of four switches, ten switches or sixteen switches.

8. The system according to claim 1, wherein the system has an input interface connected to the first potential and the second potential, wherein the system has an output interface connected to the power contacts, and wherein the switching unit is arranged between the input interface and the output interface.

9. The system according to claim 1, wherein the contacts also include at least one control contact for detecting a contacting, wherein the at least one control contact is formed separately from the power contacts and separately from the at least one protective earth contact.

10. The system according to claim 1, wherein the system includes a vehicle contact unit, which comprises the plurality of contacts, and/or a charging infrastructure, which comprises a ground contact unit which has a plate-shaped base body having a charging surface on which the plurality of contacts is arranged and against which the vehicle contact unit can come to rest.

11. The system according to claim 2, wherein the power contacts are assigned to four power contact planes which are adapted to be connected to a neutral and three phases.

12. The system according to claim 3, wherein the contact switches are each designed as mirror contacts and have a main contact and a monitoring contact which are mechanically coupled but are galvanically isolated from each other.

13. The system according to claim 4, wherein each of the four types of power contacts is assigned to a corresponding power contact plane of the four power contact planes.

14. The system according to claim 6, wherein the at least one protective earth contact is arranged in a center of the rectangle or wherein the at least one protective earth contact is formed by a continuous surface which provides a protective earth plane which is interrupted by the power contacts.

15. The system according to claim 7, wherein the switches are each designed as mirror contacts and have a main contact and a monitoring contact which are mechanically coupled but are galvanically isolated from each other.
